(19) United States
(12) Patent Application Publication
(10) Pub. No.: US 2002/0087523 A1
(43) Pub. Date: Jul. 4, 2002

(54) Custom domain generator method and system

(76) Inventor: Karthikeyan Sivaraman, Stamford, CT (US)

Correspondence Address: Daniel F. Perez, Bickel & Brewer, 4800 Bank One Center, 1717 Main Street, Dallas, TX, 75201, US

(21) Appl. No.: 09/751,713

(22) Filed: Dec. 29, 2000

Related U.S. Application Data
(60) Provisional application No. 60/225,203, filed on Aug. 14, 2000.

(51) Int. Cl. G06F 7/00

(52) U.S. Cl. 707/3

(57) ABSTRACT

A method and system in a remote computer network (80) for creating custom domains, wherein said remote computer network (80) comprises at least one client (92) connected to one or more servers (88), such that at least one of said servers (88) is designated as a knowledge system server (403) within said remote computer network (80). A knowledge system associated with the knowledge system server may be searched, wherein said knowledge system comprises customized domain capabilities (106) for the identification of nodes (304, 308, 314, 316) across all domains managed by said knowledge system server. All domain trees associated with said knowledge system may be traversed in order to construct at least one new domain tree associated with said knowledge system. Thereafter, at least one new domain representing data managed by said knowledge system server may be implemented.

### BACKGROUND

The development of computerized information resources, such as the “Internet,” and the proliferation of “Web” browsers, permit users of dataprocessing systems to link to other servers and networks, and thus retrieve vast amounts of electronic information heretofore unavailable in an electronic medium. Such electronic information generally is increasingly displacing more conventional means of information transmission, such as newspapers, magazines, and even television. As a result of this displacement, commercial enterprises and endeavors previously practiced only by conventional means of information transmission, are now being implemented and practiced via the “Internet” and “Web” browsers.

The term “Internet” is an abbreviation of “Internetwork,’ and refers to the collection of networks and gateways that utilize the TCP/IP suite of protocols, which are well known in the art of computer networking. TCP/IP is an acronym for “Transport Control Protocol/interface Program,” a software protocol originally developed by the Department of Defense for communication between computers, but now primarily utilized as one of a number of standardized Internet communications protocols.

In the last decade of the 20^{th} century, explosive growth occurred in the use of the globally-linked network of computers now known as the “Internet.” In particular, the World Wide Web, or simply the “Web,” which facilitates the use of the Internet, has resulted in a revolution of electronic commerce and information transmission. The World Wide Web, well known in the Internet and computer networking arts, is generally composed of many pages or files of information distributed across a variety of computer servers and systems.

In order to utilize the World Wide Web, a client computer system runs a portion of software known as a graphical “Web” browser, such as Netscape Navigatoror Intemet Explorer. “Netscape” and “Navigator” are trademarks of the Netscape Communications Corporation, while “Internet Explorer” is a trademark of Microsoft. The client computer system interacts with the browser to select a particular Uniform Resource Locator (URL), by which each page is identified. The URL denotes both the server machine, and the particular file or page on that machine. Many pages or URLs may reside on a single server. The selection of the URL in turn causes the browser to send a request for that URL or page to the server identified in the URL. Typically the server responds to the request by retrieving the requested page, and transmits the data for that page back to the requesting computer system. This page can be then displayed for the user to view on the client screen. The client may also cause the server to launch an application, for example, to search World Wide Web “pages” relating to particular topics.

Most World Wide Web pages are formatted in accordance with a computer program written in a language known as HTML (hypertext mark-up language). This program contains the data to be displayed via the client's graphical browser as well as formatting commands which “tell” the browser how to display the data. Thus, a typical “Web” page includes text together with embedded formatting commands, referred to as “tags,” which can be utilized to control the font size, the font style (e.g., italic or bold), textual layout, and so forth. A Web browser “parses” the HTML script in order to display the text in accordance with the specified format. HTML tags are also utilized to indicate how graphics, audio, and video are manifested to the user via the client's browser.

The majority of Web pages also contain one or more references to other Web pages, which need not be on the same server as the original page. Such references may generally be activated by the user selecting particular locations on the screen, typically by clicking a mouse control button. These references or locations are known as hyperlinks, and are typically flagged by the browser in a particular manner (e.g., any text associated with a hyperlink may appear graphically in a different color). If a user selects the hyperlink, then the referenced page can be retrieved, thereby replacing the currently displayed page.

Commercial enterprises, organizations, and companies are actively utilizing the World Wide Web to initiate commerce. Several phases of electronic commerce via the World Wide Web have taken place. The first phase, namely publicity for companies and organizations, has already occurred. Homepages are commonplace, an essential ingredient for any company which wishes to maintain itself in line with current business practices. The publicity material posted electronically on company homepages contain marketing information, product brands, and in some cases, product catalogues.

The second phase, namely to conduct commerce, is generally emerging. Enterprises are poised to conduct business via the World Wide Web. They are seeking to make sales of their products and services, utilizing the World Wide Web. Software infrastructure is generally coming into existence to enable the progress of this trend. Secure financial protocols have been defined and are being implemented. The provision of firewall technologies offer safeguards to the enterprise, without which the enterprise would not contemplate permitting access to its critical data. Gateway products are becoming available to facilitate connection between the World Wide Web and server machines owned and operated by companies and commercial enterprises.

The third phase of commercial World Wide Web development, namely, the business-to-business arena, generally is only now being seriously implemented. Web business-to-business solutions require two components. First, a customer must be willing to engage in commercial transactions via the World Wide Web. Second, the company or enterprise expecting customer participation must offer and implement a secure and efficient electronic information delivery system.

Based on the foregoing, those skilled in the art can appreciate that organizations and businesses which utilize Internet-based applications and remote computer networks thereof are increasingly faced with growth and quality issues. Growth and quality are just two of the critical elements in professional service-based environments that have created the need for knowledge sharing. Most financial institutions, for example, have realized significant organizational growth over the last ten years—both domestically and internationally. As a result, demands on time have increased dramatically. Experts no longer seem to have adequate time to entertain repeated phone calls on the same question or provide the one-on-one coaching that many new professionals may require. Likewise, professionals are generally experiencing less time to seek out the information required to perform their jobs effectively. Growth requires hiring additional resources to sustain itself. Growth also creates training and mentoring needs throughout an organization.

With the rapid growth experienced in the financial services industry, driven in large part by the proliferation of new technologies, such as the Internet and World Wide Web, new personnel are hired at such a fast rate that it is often difficult to quickly achieve the level of skill and experience necessary to adequately perform their jobs and quickly advance in their given occupational fields. To fill the growing service pipeline, it is sometimes necessary to hire less experienced professionals and thereafter invest in their continued training to thereby increase their skills and ability to contribute to their company or organizational growth. Knowledge sharing is essential to supporting organizational and economic growth. Knowledge sharing also provides a framework for disseminating expert information and experience across a given organization. Knowledge sharing places experience in the hands of the professionals who need it the most—those decision-making individuals further down in the organizational hierarchy. Such individuals are typically closerto the customer. Thus, it can be appreciated that knowledge sharing is becoming increasingly critical to maximizing quality efforts.

By sharing experience across an organization, service providers can learn from others' mistakes so that future products and programs satisfy the ultimate recipient. Knowledge systems and solutions are useful when available to broader audiences over various mediums, such as the Internet and storage media, such as CD-ROM, DVD, and other optical storage devices. Unfortunately, many solutions previously available on CD-ROM and other such media storage devices generally require substantial modifications to be utilized in a network-based framework. Such software generally must be rewritten and configured for network-based use, and network-based solutions generally require reformatting and, oftentimes, substantial re-programming in order to create a comparable version of a network solution on portable memory means (e.g., CD, DVD, and so forth).

A similar issue occurs when a network accessible version of a solution typically available over the network is desired. Additional programming and formatting must generally be undertaken for the alternate presentation medium, such as Compact Disk. Furthermore, enterprises providing software solution in stand-alone CD-ROM versions, as well as access to the same solution over a network, are required to provide logistics to generate medium specific software versions.

Based on the foregoing, it can thus be appreciated that what is needed to address these problems, are methods and systems that enable the conversion of network-based solutions into media storage solutions, such as CD-ROM, DVD and so forth, while reducing logistical and programming requirements. It is believed that the present invention described herein solves these problems by providing a unique software application converter utilized in accessing software applications.

### SUMMARY

It is one aspect of the present invention to provide a tool that facilitates the conversion of network-based knowledge solutions into portable memory-based (e.g., compact disk-based) solutions.

It is another aspect of the present invention to provide methods and systems for facilitating the creation of custom domains from information available over networks.

It is still another aspect of the present invention to provide a method for creating a custom domain.

The above and other aspects of the present invention are achieved as is now described. A search may be performed on a knowledge system having custom domain capability to identify nodes across all available domains managed by a knowledge system server. A custom domain tool can traverse all domain trees associated with the knowledge system to build a new custom domain tree. A newly formed custom domain can be then provided which represents data managed by the knowledge system server.

In accordance with another aspect of the present invention, a system for creating a custom domain is provided. The system includes a custom domain tool having access to a knowledge system server, and providing access to a search engine, wherein the custom domain tool cooperates with the search engine to perform a search on a knowledge system to identify nodes across all available domains managed by a knowledge system server, the converter traversing all domain trees associated with the knowledge system to build a new custom domain tree, wherein the converter providing a newly form custom domain representing data managed by the knowledge system server.

### BRIEF DESCRIPTION OF DRAWINGS

FIG. 1 illustrates a pictorial representation of a computer system, which may be utilized to implement a preferred embodiment of the present invention;

FIG. 2 depicts a representative hardware environment of a computer system in which a preferred embodiment of the present invention can be implemented;

FIG. 3 illustrates a block diagram illustrative of a client/server architecture, in accordance with a preferred embodiment of the present invention;

FIG. 4 depicts a detailed block diagram of a client/server architecture in accordance with a preferred embodiment of the present invention;

FIG. 5 illustrates a block diagram of a computer network in which a preferred embodiment of the present invention can be implemented;

FIG. 6 illustrates a block diagram illustrative of a system for generating network-based knowledge solution from data also usable for creating CD-based solutions, in accordance with a preferred embodiment of the present invention;

FIG. 7 depicts a block diagram illustrative of a system for generating network-based knowledge solutions, in accordance with a preferred embodiment of the present invention;

FIG. 8 illustrates a block diagram of a content hierarchy for a knowledge domain, in accordance with a preferred embodiment of the present invention;

FIG. 9 depicts a block diagram illustrative of a system for creating custom domains, in accordance with a preferred embodiment of the present invention;

FIG. 10 illustrates a custom domain creation process, in accordance with a preferred embodiment of the present invention; and

FIG. 11 depicts a system diagram of hardware utilized at stages from development to publication of knowledge solution/system, in accordance with a preferred embodiment of the present invention.

### DESCRIPTION OF PREFERRED EMBODIMENTS

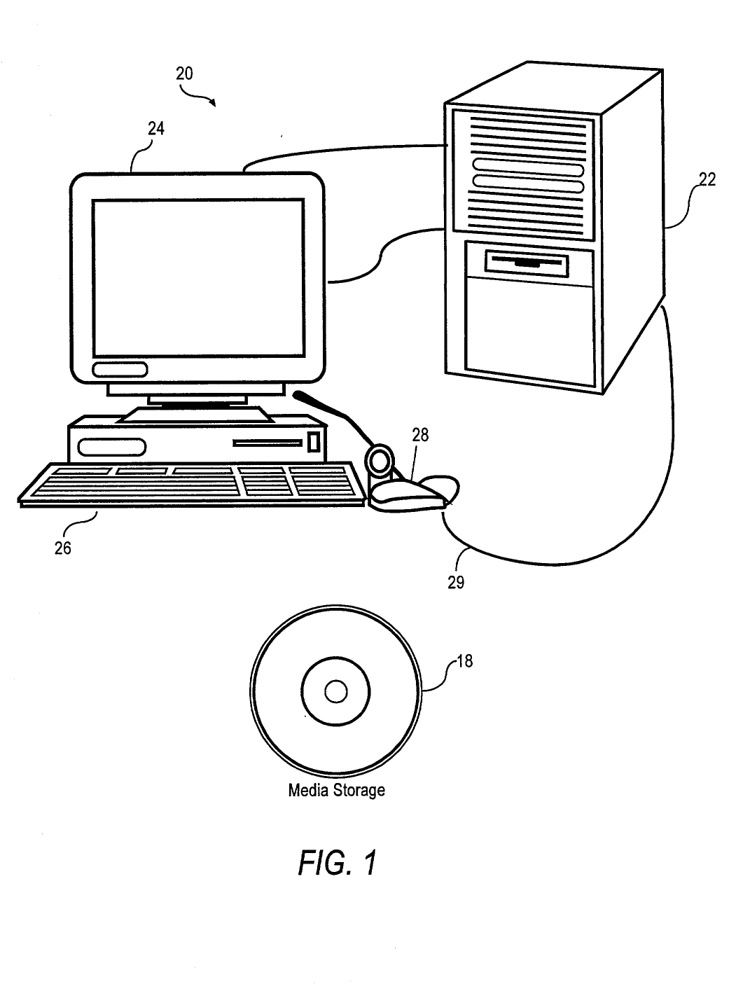

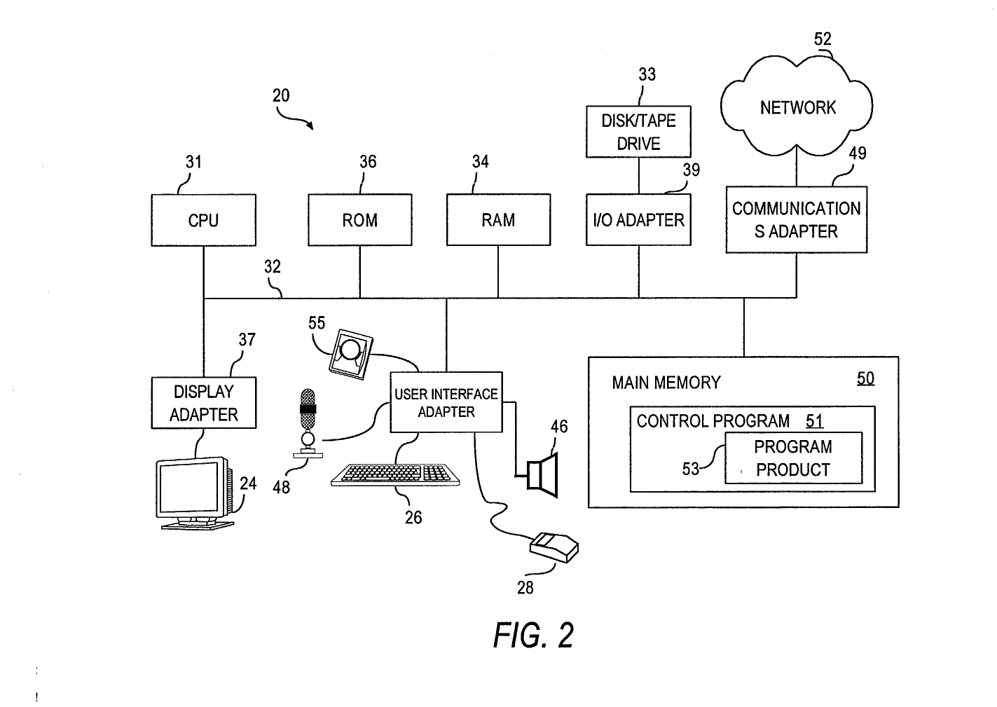

FIG. 1 illustrates a pictorial representation of a computer system 20, which may be utilized to implement a preferred embodiment of the present invention. Computer system 20 includes a system unit 22, a video display terminal 24, a keyboard 26, and a mouse 28. Those skilled in the art can appreciate that the method and system of the present invention apply equally to any computer system, regardless of whether the computer system is generally implemented as a complicated multi-user computing apparatus or a single-user workstation. FIG. 1 further illustrates a transportable memory 18 configured as a CD-ROM type of media storage device. Such a transportable memory or media storage device can be utilized in accordance with a preferred embodiment of the present invention. In FIG. 1 and FIG. 2, analogous parts are identified by identical reference numerals.

FIG. 2 depicts a representative hardware environment of the computer system of a preferred embodiment of the present invention. Computer system 20 includes a Central Processing Unit (“CPU”) 31, such as a conventional microprocessor, and a number of other units interconnected via system bus 32. Such components and units of computer system 20 can be implemented in a system unit such as system unit 22 of FIG. 1. Computer system 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

Video display terminal 24 generally provides the visual output of computer system 20. Video display terminal 24 can be implemental as a CRT-based video display, well known in the art of computer hardware. In the context of a portable or notebook-based computer, however, video display terminal 24 can be replaced with a gas plasma-based or LCD-based flat-panel display. Computer system 20 further includes user interface adapter 40 for connecting keyboard 26, mouse 28, speaker 46, microphone 48, and/or other user interface devices, such as a touch-screen device (not shown), to system bus 32. Other user interface devices that can be utilized in accordance with the method and system of the present invention include a track-ball device 55.

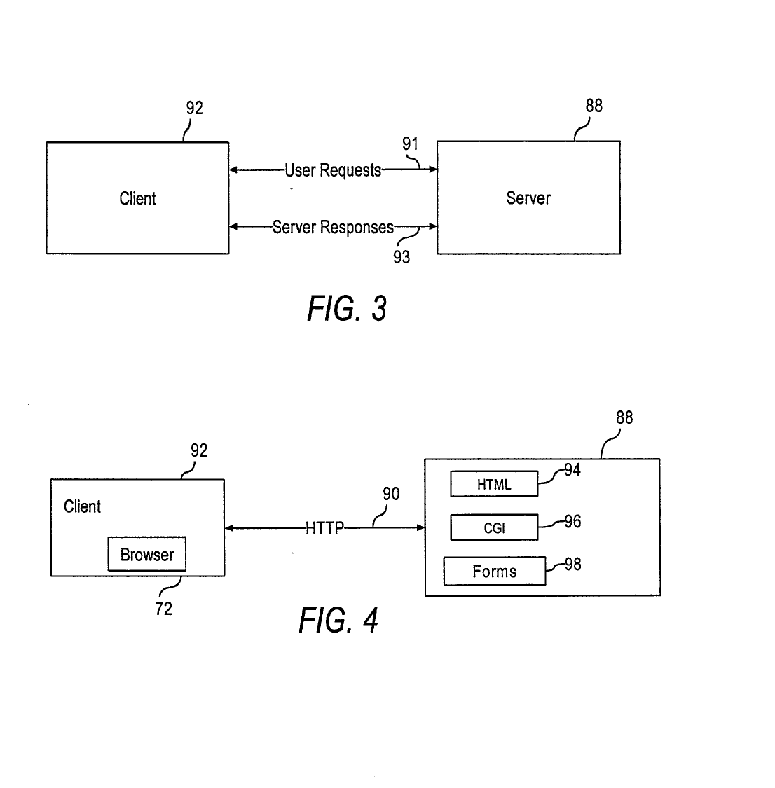

Communications adapter 49 connects computer system 20 to a computer network 52, such as the remote computer network described and illustrated herein with reference to FIGS. 3 to 5. Although computer system 20 is shown to contain only a single CPU and a single system bus, it should be understood that the present invention applies equally to computer systems that have multiple CPUs and to computer systems that have multiple buses that each perform different functions in different ways.

Computer system 20 also includes an interface that resides within a machine-readable media to direct the operation of computer system 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. Other technologies also can be utilized in conjunction with CPU 31, such as touch-screen technology or human voice control. Those skilled in the art can appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted.

Main memory 50 is connected to system bus 32, and includes a control program 51. Control program 51 resides within main memory 50, and contains instructions that, when executed on CPU 31, carries out the operations depicted in the logic flow diagrams described herein. Control program 51, a computer program product, can also be referred too simply as a program product. Such a program product 53 is illustrated in FIG. 2.

It is important to note that, while the present invention has been (and will continue to be) described in the context of a fully functional computer system, those skilled in the art can appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

The program product itself may be compiled and processed as a module. In programming, a module is typically organized as a collection of routines and data structures that perform a particular task or implements a particular abstract data type. Modules are typically composed of two portions, an interface and an implementation. The interface lists the constants, data types, variables, and routines that can be accessed by other routines or modules. The implementation is private in that it is only accessible by the module. The implementation also contains source code that actually implements the routines in the module. Thus, a program product can be formed from a series of interconnected modules or instruction modules dedicated to working together to accomplish a particular task.

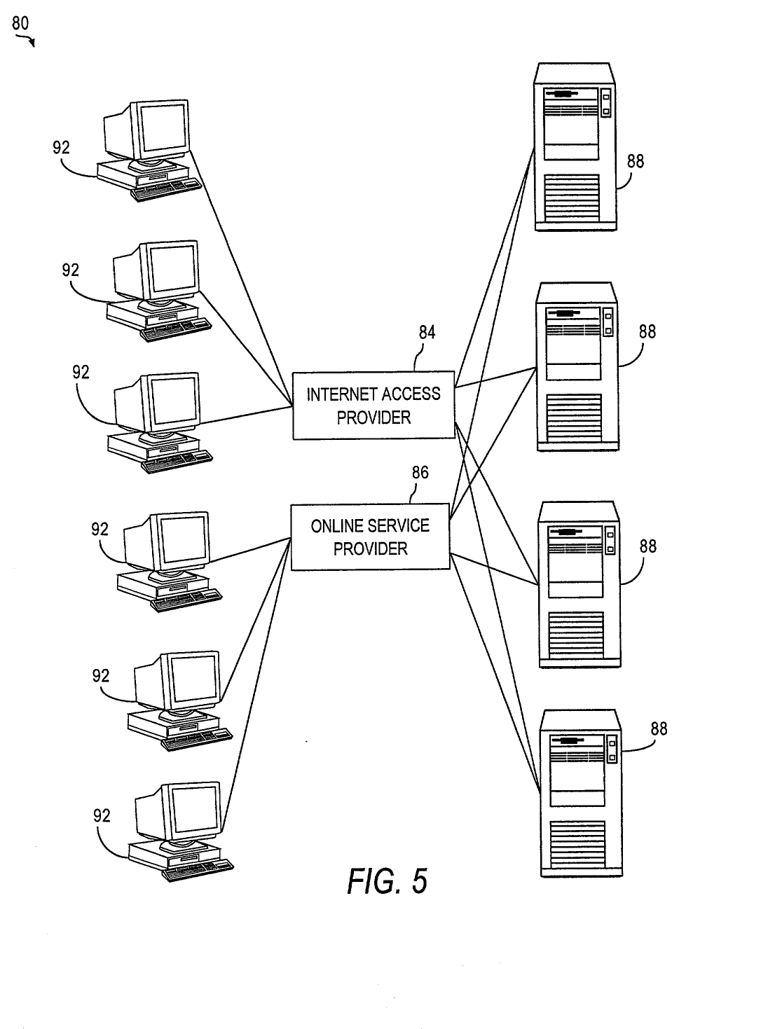

In FIG. 3, FIG. 4, and FIG. 5, like parts are indicated by like numbers. FIG. 3 illustrates a block diagram illustrative of a client/server architecture in accordance with a preferred embodiment of the present invention. In FIG. 3, user requests 91 for news are sent by a client application program 92 to a server 88. Server 88 can be a remote computer system accessible over the Internet or other communication networks. Client application program 92 may be utilized in association with computer 10 of FIG. 2 and the implementation of computer 10, as illustrated in FIG. 3.

Server 88 performs scanning and searching of raw (e.g., unprocessed) information sources (e.g., newswire feeds, news groups, and specialized or targeted Website content) and, based upon these user requests, presents the filtered electronic information as server responses 93 to the client process. The client process may be active in a first computer system, and the server process may be active in a second computer system, communicating with one another over a communications medium, thus providing distributed functionality and allowing multiple clients to take advantage of the information-gathering capabilities of the server.

FIG. 4 illustrates a detailed block diagram of a client/server architecture in accordance with a preferred embodiment of the present invention. Although the client and server are processes that are operative within two computer systems, these processes being generated from a high-level programming language (e.g., PERL), which is interpreted and executed in a computer system at runtime (e.g., a workstation), it can be appreciated by one skilled in the art that they may be implemented in a variety of hardware devices, either programmed or dedicated.

Client 92 and server 88 communicate utilizing the functionality provided by HTTP. Active within client 92 is a first process, browser 72, which establishes connections with server 88, and presents information to the user. Any number of commercially or publicly available browsers can be utilized in various implementations in accordance with the preferred embodiment of the present invention. For example, Netscape can be utilized in accordance with a preferred embodiment of the present invention. Other browsers also provide the functionality specified under HTTP. “Netscape” is a trademark of Netscape, Inc.

Server 88 executes the corresponding server software, which presents information to the client in the form of HTTP responses 90. The HTTP responses 90 correspond with the Web pages represented using HTML, or other data generated by server 88. Server 88 provides HTML 94. With certain browsers, a Common Gateway Interface (CGI) 96 is also provided, which allows the client program to direct server 88 to commence execution of a specified program contained within server 88. This may include a search engine that scans received information in the server for presentation to the user controlling the client. A search engine, well known in the Internet arts, may be implemented as a program or software module that searches for key words in documents or databases. In the context of a remote computer network, such as the Internet, such a search engine may be implemented as a program that searches for keywords in documents or files on the World Wide Web, newsgroups, FTP archives, and so forth. Some search engines can be implemented with a single Internet site, such as a dedicated search engine for a Web site. Search engines are well known in the art and further explanation is not necessary.

By utilizing this interface, and HTTP responses 90, server 88 may notify the client of the results of that execution upon completion. Common Gateway Interface (CGI) 96 is one form of a gateway, a device utilized to connect dissimilar networks (i.e., networks utilizing different communications protocols) so that electronic information can be passed from one network to the other. Gateways transfer electronic information, converting such information to a form compatible with the protocols used by the second network for transport and delivery.

In order to control the parameters of the execution of this server-resident process, the client may direct the filling out of certain “forms” from the browser. This is provided by the “fill-in-forms” functionality (i.e., forms 98), that is provided by some browsers, such as the Netscape-brand browser described herein. This functionality allows the user via a client application program to specify terms in which the server causes an application program to function (e.g., terms or keywords contained in the types of stories/articles, which are of interest to the user). This functionality is an integral part of the search engine.

FIG. 5 is a diagram illustrative of a computer network 80, which can be implemented in accordance with a preferred embodiment of the present invention. Computer network 80 is representative of the Internet, which can be described as a known computer network based on the client-server model discussed herein. Computer network 80 is thus a remote computer network, which can be configured as the Internet and/or the so-called Intranet. Conceptually, the Internet and to a lesser extent, an internal Intranet, includes a large network of servers 88 that are accessible by clients 92, typically users of personal computers or through wireless means, such as Wireless Application Protocol (WAP) enabled hand held devices, through some private Internet access provider84 (e.g., such as InternetAmerica) oran on-line service provider 86 (e.g., such as America On-Line, Prodigy, Juno, and the like). Each of the clients 92 may run a browser to access servers 88 via the access providers. Each server 88 operates a so-called “Web site” that supports files in the form of documents and web pages. A network path to servers 88 is identified by a Universal Resource Locator(URL) having a known syntax for defining a network collection. Computer network 80 can thus be considered a Web-based computer network.

Conversion methods and systems, referred to herein as a conversion tool or converter, has been developed by applicants to convert a network-capable version of a knowledge system into knowledge system software that is navigable and usable over stand-alone environments, such as a CD-ROM or DVD (Digital Video Disk) compatible medium on a desktop or laptop computer. The tool can read network versions of software and convert it into CD-ROM application without the need for programmer intervention and/or code writing efforts.

The converter reads and converts a software solution accessible over an Intranet into a self-contained software solution embodied within a CD. The converter facilitates the creation of a CD version as Java Applets and/or as HTML. Those skilled in the art can appreciate that HTML is generally utilized as the mark-up language for documents on the World Wide Web. The term HTML is an acronym for Hypertext Markup Language. HTML is a well known networking scripting language. A Java Applet is another well known remote computer networking tool. Java Applet is generally a Java class that is loaded and run by an already-running Java application, such as a web browser or an applet viewer. Java applets can be downloaded and run by any web browser capable of interpreting Java, such as Netscape or Internet Explorer. Java is a well known object oriented programming language and thus a further description of Java is not necessary.

InSIGHT is a Java-based knowledge system accessible via networks or standalone devices using a memory-based solution (e.g., compact disk, or the like). InSIGHT, as described herein, refers generally to a method and system developed by General Electric. Knowledge Solutions available over a network or embodied within a compact disk may be Java or HTML-based. The converter enables users to seamlessly use the same application in standalone and network-based versions. Both mediums only require a single data load. The converter reads the network solution to create a standalone program on CD. The CD solution may be provided in Java or HTML formats.

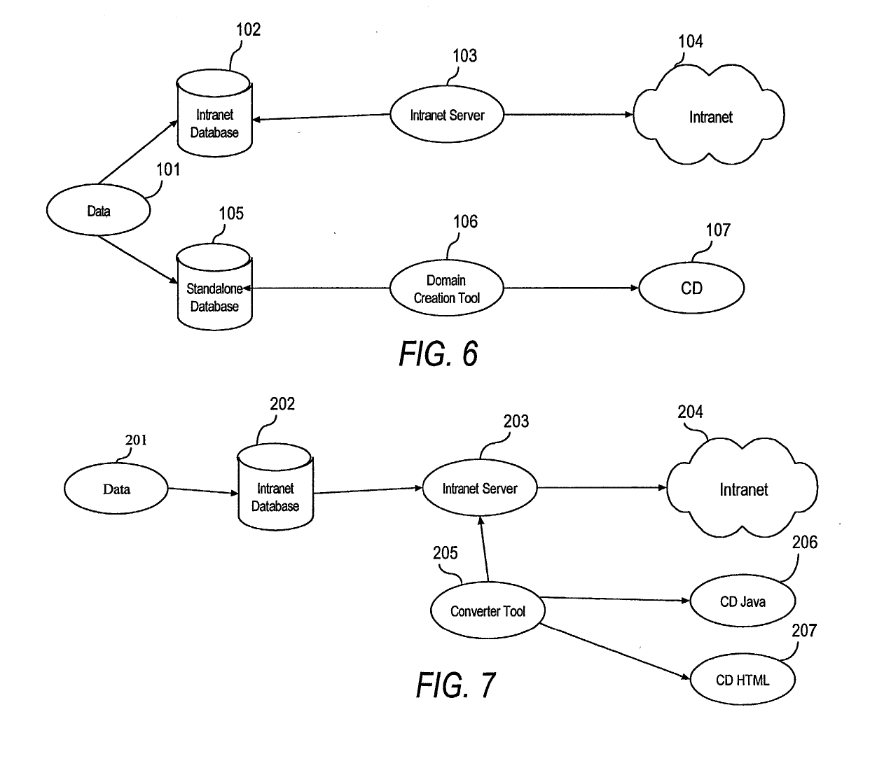

FIG. 6 illustrates a block diagram illustrative of a system for generating network-based knowledge solution from data also usable for creating CD-based solutions, in accordance with a preferred embodiment of the present invention.

Referring to FIG. 6, Data 101 may be stored within a database. If the desired knowledge solution is to be network-based, data may be stored within a network database 102, which is labeled in FIG. 6 as Intranet Database. In the example depicted in FIG. 6, the network-based knowledge solution may be generated from an Intranet-type network connected through an external firewall to the Internet 104. Those skilled in the art will appreciate that an Intranet is a term of art utilized to describe a network designed for information processing within a company or enterprise. An intranet-type network typically may provide services to employees or enterprise members, such as document distribution, software distribution, database access, and training. Such networks are referred to as “Intranet” because they typically employ applications associated with the Internet, such as Web pages, Web browsers, FTP sites, newsgroups, e-mail capabilities, mailing lists, and other information accessible only to those individuals with the company or enterprise.

Thus, as illustrated in FIG. 6, data may be read from network database 102 by a network server 103, which is labeled Intranet Server. Code operating within network server 1030 can be generally Java-based. Network server 103 creates a domain-based tagging system for presentation and operation of a solution over the network 104, labeled Intranet

When a static, or CD version of the solution is desired, techniques known in the art may be utilized to create a CD-based solution. As illustrated in FIG. 6, data 101 may be generally provided to a standalone database 105. The solution/data may be read from the standalone database 105 by a domain creation tool 106. Code may be generally presented in Delphi-based code format. Domain creation tool 106 creates domains for the solution and data to be stored on a CD 107. CD 107 is one type of recordable storage medium that may be utilized in accordance with preferred embodiments of the present invention. Other storage and recordable media may be last disks, such as DVDs, which are well known in the art or other recordable storage media, such recordable CDs (e.g, CD-R) or CD-ROM type disks. In any event, the CD 107 based solution may operate in isolation (not networked) on a standalone computer.

FIG. 7 depicts a block diagram illustrative of a system for generating network-based knowledge solutions, in accordance with a preferred embodiment of the present invention. Referring to the block diagram of FIG. 7, an alternative system and method of generating network-based knowledge solution from data also usable for creating CD-based solutions is illustrated. As with the network-based method described in FIG. 6, data 201 may be provided for storage in a network database 202. Data can be read by a network server 203. As with FIG. 7, the server 203 publishes the knowledge solution on the network 204 in Java format. With the present invention, however, the same Java-based information may be read from server 203 by a converter 205 (i.e., a converter tool) to create either a Java Applet software version 206 of the knowledge solution/system publishable on CD ROM and/or as an HTML-based solution 207 also publishable on CD. Only Java-based code is initially utilized for network publicity 204 or conversion 205 according to the present embodiment.

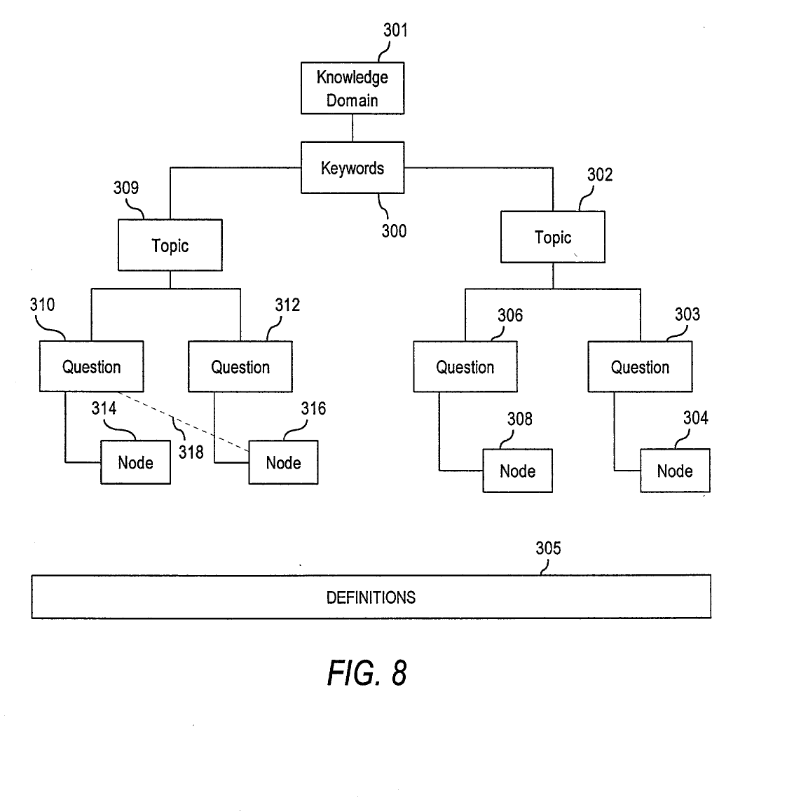

FIG. 8 illustrates a block diagram of a content hierarchy for a knowledge domain, in accordance with a preferred embodiment of the present invention. Referring to FIG. 8, a graphical illustration of a knowledge domain content hierarchy that may be utilized within the present knowledge solution conversion tool is provided. The hierarchy is initiated with a Knowledge Domain 301, which delineates a business problem addressed by the expert knowledge system. Then keywords 300 delineate business sub-processes or sub-areas of a specific knowledge domain. Thereafter, topic 302, which contains topical information, or content areas related to the business problem, can be categorized under a Knowledge Domain 301. Next, Questions 303 can be categorized under topic 302, with questions 303 linking topic 302 and expert content through a set of inquiries regarding topic 302. Finally, a node 304 (i.e., one or more nodes) can be established in association with question 303, which may contain one or more questions. Node 304 may be characterized by answers to the questions 303 via expert analogies, stories, best practices, sample documents, short learning activities, and so forth. The content of a single node may answer more than one question. Definitions 305 may be accessible at all stages (i.e., Knowledge Domain, keywords, Topics, Questions, Nodes) to explain terminology within the Knowledge Domain 301. Those skilled in the art will appreciate that a similar process may occur through question 306 and node 308, and likewise through topic 309, questions 310 and 312 and nodes 314 and 316. Node 316 may alternatively depend from question 310, as indicated by dashed line 318.

According to the present invention described herein, information and/or data associated with a knowledge solution may be grouped into customized domains. The present invention, when implemented, can result in the creation of a custom knowledge domain based on InSIGHT-related domains. Through methods of tagging and formatting information, the converter may keep track of associations (e.g., domains through nodes) for a particular knowledge system (e.g., such as InSIGHT) during conversion to, for example, a Compact Disk medium. Customized domains may lead to keywords and keywords may lead to topics and topics may lead to questions.

During use of a knowledge system configured with custom domains, a user may query the knowledge system with a question regarding a certain topic. The knowledge system generally has custom domain building capabilities A user may be provided with a question or series of questions that may lead the user to a video that provides an explanation or simulation associated with the subject matter. For example, subject matter experts with experience in the field may inform a user how to go about doing something associated to the topic and relevant question or questions.

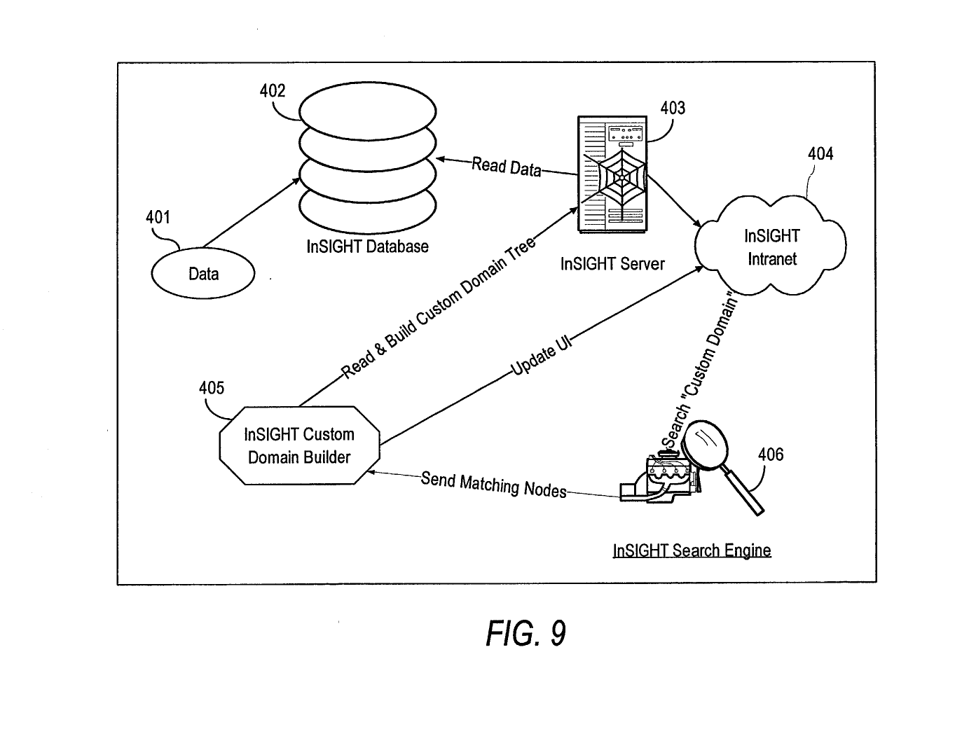

FIG. 9 depicts a block diagram illustrative of a system for creating custom domains, in accordance with a preferred embodiment of the present invention. Data 401 associated with topics is generally stored in a database 402, referred to in FIG. 9 as InSIGHT Database. A server 403, referred to as InSIGHTServer, reads data from database 402, or other data resources, and creates domains associated with information categories (e.g., see FIG. 5). Information and relevant domains may be accessible to users over network 404, referred to in FIG. 9 as InSIGHT Intranet, or may be provided on memory suitable for standalone application (e.g., CD-ROM, DVD, and so forth). A custom domain tool 405 allows divers domains usually managed by server403 to be streamlined into a customized domain. The custom domain tool traverses all domain trees generally available to server 403 and constructs a custom domain tree. The custom domain tree may be searchable utilizing a search engine 406. Search engine 406 triggers custom domain tool 405, and updates the user interface seen by the user through network 404 with a presentation associated with the custom domain tree. Server 403 may provide information to the user in the custom domain tree format.

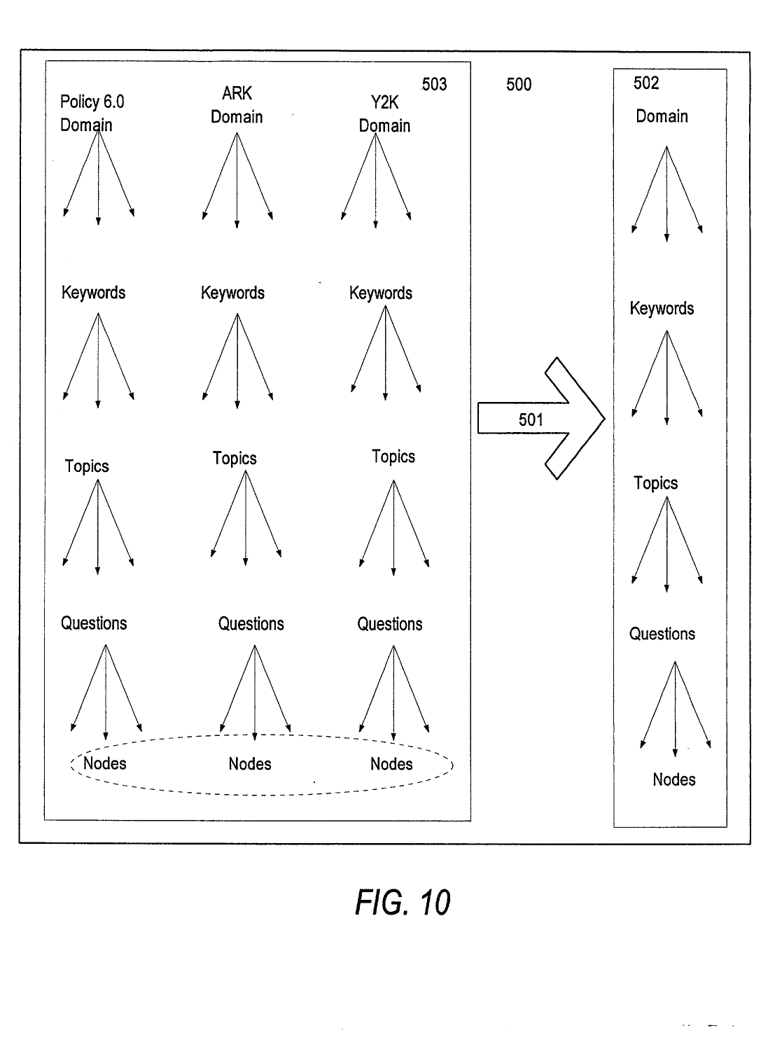

FIG. 10 illustrates a custom domain creation process, in accordance with a preferred embodiment of the present invention. Referring to FIG. 10, a list of domains for several topics are illustrated on the left side of the page (e.g., Policy 6.0, ARK, Y2K). Taking Policy 6.0, for example, the domain had associated Keywords, Topics, Questions and information Nodes. In accordance with the process described in FIG. 10, all of the topics associated with the knowledge system, Policy 6.0 through Y2K, may be converted utilizing the custom domain tool 501 into a Custom Domain 502 that provides for simplified management of keywords topic questions and information for the newly assembled “Custom Domain.”

The three steps typically undertaken to create the custom domain are to first perform a search on a “custom domain” to identify nodes across all available domains (e.g, Policy 6.0, ARK, Y2K). Secondly, the converter traverses all domain trees to build a new custom domain tree. Finally, the newly formed custom domain is loaded into a newly formed knowledge solution interface.

The initial search conducted without using the custom domain tool generally provides a userwith more information than is desired or needed. Much information is generally outside a topic area of concern to the user. With a customized domain builder, a user will retrieve information, either topical or directly as nodes, that are most directly related to the topical area—thus enhancing the quality of the user's search. Custom domain searches should provide a user with links to real information (e.g., expert video, power point presentation, notes) without having to cull through topics or traverse a information tree.

From an exploratory standpoint, custom domain searching methods may provide users with a bottom up way of navigating through information (as opposed to the top down method known in the art for Internet-type search engines, where the user is provided with ranked topics and must drill down into the media to find data). A custom domain search engine enables users to directly access information or explore link/related information based on the users query.

The custom domain methods will also rank information based on relevance to a user query. The user, however, has more direct access to actual information contained within data filed such as real video, presentation, etc.

The search engine for custom domain may analyze/search what is contained within data, for example the abstract in scripts. It builds a reference to a particular object within data that is associated to a user's search. The custom domain tool builds a tree for questions, associates topics and then sorts keyword associated with topics. The custom domain builder/tool assumes there is a structure already in place, which should normally be the case with knowledge system such as InSIGHT. Most public Websites do not have a predictable structure.

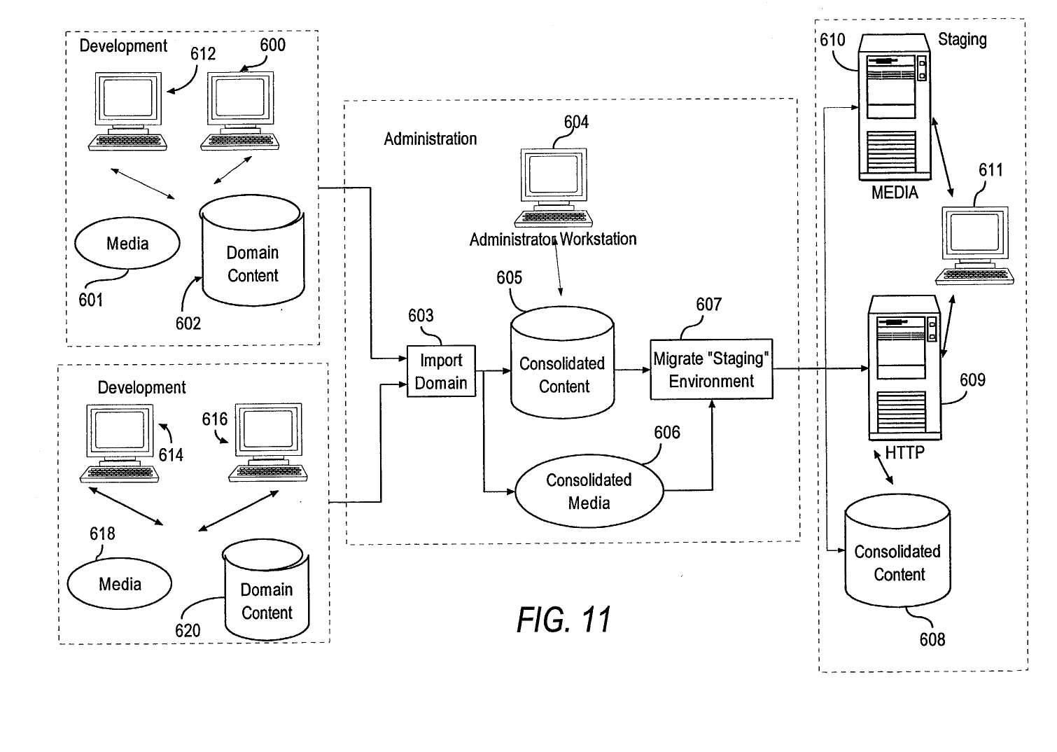

FIG. 11 depicts a system diagram of hardware utilized at stages from development to publication of knowledge solution/system, in accordance with a preferred embodiment of the present invention. Referring to FIG. 11, hardware utilized in the development, conversion and publicity of knowledge-based solutions is illustrated. During the development phase for knowledge-based software, media 601 and content 602 are assembled by developers 600. Tagging and categorizing is generally accomplished during development. Resulting solutions represented a tree-like structure represented in FIG. 8 can be imported 603 into a administrator workstation 604 that generally includes access to a consolidated content database 605 and media content 606. An operational solution may be migrated 607 into the staging environment where it is stored in a consolidated database 608 at the staging environment. Network 609 and media 610 servers may then provide knowledge to users 611 over networks.

During administration, consolidated data contained within the database may also be extracted by the conversion tool to develop CD-ROM based solutions as illustrated in FIG. 7. The media server and HTTP server both have access to the consolidated database with contents representing the knowledge-base solution. Access to the solution at the staging point of the process may also enable medium conversion by the conversion tool.

The conversion tool may be adjusted prior to creation of a CD-ROM version of the network-based solution. Adjustments may be necessary, for example, where the intended use will be on devices having limited graphics (e.g., palm computing devices, Web-phones). For example, if graphics are not desired, a solution may be generated that does not have graphics, but only contains use of text (such a result being useful for current Web-phone applications wherein only text is supported).

It should be appreciated that the conversion tool may be utilized to convert network-based knowledge solutions into medium accessible over wireless networks. For example, wireless devices may utilize a wireless application protocol to read data from the Internet. Conversion may be taken into whatever protocol or standard is used by a device, such as Java, WAP (Wireless Application Protocol), XML (Extensible Markup language) or HTML (Hypertext markup Language).

InSIGHT has been used an a example of a knowledge solution/system for the purpose of describing the present invention. The value of knowledge systems and solutions is apparent where a user may have a critical problem that needs to be answered, but cannot get an expert on the phone immediately where such a system is generally prohibitive based on typical enterprise resource allocations. In the real world, a user would not generally be able to get an expert assistance on demand.

Intelligent Knowledge-based systems like InSIGHT provide an efficient and practical way for a company to share the knowledge and experiences of their experts with less experienced employees, in a risk-free environment. This knowledge and experience is wrapped in the context of a story which then provides an anchor point for the learner to reflect on in future relevant circumstances, without having actually experiencing the critical event.

Knowledge systems may allow a learner to obtain the answer to an immediate question, obtain relevant information, and explore other areas of interest. InSIGHT, for example, is easy to use, allowing the learner immediate access to expert knowledge. Learners have complete control over what is seen/obtained from the moment the system is entered.

The present inventors thus realize, based on the foregoing, that knowledge systems should provide a number of benefits, including answers to the learner's questions at the point of need, incidental learning through exploration of related topics, and access to experts in a risk-free environment. Additional benefits are noted, including information delivered in a meaningful and memorable context, subtle reinforcement of corporate culture, and an acceleration of the experience level of employees by adding to their case knowledge. Additionally, many learners can experience the same, consistent message from the same source, without the expert having to physically appear each time.

The embodiments and examples set forth herein are presented in order to best explain the present invention and its practical applications and to thereby enable those skilled in the art to make and utilize the invention. Those skilled in the art can recognize that the foregoing description and examples have been presented for the purposes of illustration and example only. Thus, the description as set forth herein is not intended to be exhaustive or to limit the invention to the precise form disclosed. Many modifications and variations are possible in light of the above teaching without departing from the spirit and scope of the following claims.

1. A method in a remote computer network for creating custom domains, wherein said remote computer network comprises at least one client connected to one or more servers, such that at least one of said servers is designated as a knowledge system server within said remote computer network, said method comprising the steps of:
searching a knowledge system associated with said knowledge system server, wherein said knowledge system comprises customized domain capabilities for the identification of nodes across all domains managed by said knowledge system server;
traversing all domain trees associated with said knowledge system in order to construct at least one new domain tree associated with said knowledge system; and
implementing at least one new domain representing data managed by said knowledge system server.

2. The method of claim 1 further comprising the step of:
designating a search engine for searching said knowledge system.

3. The method of claim 2 further comprising the step of:
processing searches by said search engine through a server associated with said knowledge system.

4. The method of claim 1 further comprising the step of:
configuring said remote computer network as an Intranet within a particular organization.

5. The method of claim 1 wherein the step of traversing all domain trees associated with said knowledge system in order to construct at least one new domain tree associated with said knowledge system, further comprises the step of:
utilizing a converter to traverse all domain trees associated with said knowledge system in order to construct at least one new domain tree associated with said knowledge system.

6. The method of claim 5 further comprising the step of:
configuring said converter to read and convert a software solution accessible over said Intranet into a self-contained software solution that may be embodied within storage media.

7. The method of claim 5 further comprising the step of:
configuring said converter to facilitate the creation of said software solution as network data retrievable over a remote computer network.

8. A system in a remote computer network for creating custom domains, wherein said remote computer network comprises at least one client connected to one or more servers, such that at least one of said servers is designated as a knowledge system server within said remote computer network, said system comprising:
search module for searching a knowledge system associated with said knowledge system server, wherein said knowledge system comprises customized domain capabilities for the identification of nodes across all domains managed by said knowledge system server;
conversion module for traversing all domain trees associated with said knowledge system in order to construct at least one new domain tree associated with said knowledge system; and
domain module for implementing at least one new domain representing data managed by said knowledge system server.

9. The system of claim 8 wherein said search module comprises a search engine for searching said knowledge system.

10. The system of claim 9 further comprising:
processor for processing searches by said search engine through a server associated with said knowledge system.

11. The system of claim 8 wherein said remote computer network comprises an Intranet within a particular organization.

12. The system of claim 8 wherein said conversion module comprises a converter that traverse all domain trees associated with said knowledge system in order to construct at least one new domain tree associated with said knowledge system.

13. The system of claim 12 wherein said converter comprises a converter for converting a software solution accessible over said Intranet into a self-contained software solution that may be embodied within storage media.

14. The system of claim 13 wherein said converter further comprises a converter that facilitates the creation of said software solution as network data retrievable over a remote computer network.

15. A program product residing in computer memory in a remote computer network for creating custom domains, wherein said remote computer network comprises at least one client connected to one or more servers, such that at least one of said servers is designated as a knowledge system server within said remote computer network, said program product comprising:
instruction module residing in a computer for searching a knowledge system associated with said knowledge system server, wherein said knowledge system comprises customized domain capabilities for the identification of nodes across all domains managed by said knowledge system server;
instruction module residing in a computer for traversing all domain trees associated with said knowledge system in order to construct at least one new domain tree associated with said knowledge system; and
instruction module residing in a computer for implementing at least one new domain representing data managed by said knowledge system server.

16. The program product of claim 15 wherein said instruction module residing in a computer for searching a knowledge system associated with said knowledge system server comprises a search engine for searching said knowledge system.

17. The program product of claim 16 further comprising:
instruction module residing in a computer for processing searches by said search engine through a server associated with said knowledge system.

18. The program product of claim 15 wherein said remote computer network comprises an Intranet within a particular organization.

19. The program product of claim 15 wherein said instruction module residing in a computer for traversing all domain trees associated with said knowledge system in order to construct at least one new domain tree associated with said knowledge system comprises a converter that traverses all domain trees associated with said knowledge system in order to construct at least one new domain tree associated with said knowledge system.

20. The program product of claim 19 wherein said converter comprises a converter for converting a software solution accessible over said Intranet into a self-contained software solution that may be embodied within storage media.

21. The program product of claim 20 wherein said converter further comprises a converter that facilitates the creation of said software solution as network data retrievable over a remote computer network.

22. The program product of claim 15 wherein each of said instruction modules further comprise signal-bearing media.

23. The program product of claim 22 wherein said signal-bearing media comprises recordable media.

24. The program product of claim 22 wherein said signal-bearing media comprises transmission media.
